(19) United States
(12) Patent Application Publication
(10) Pub. No.: US 2008/0183680 A1
(43) Pub. Date: Jul. 31, 2008

(54) DOCUMENTS SEARCHING ON PEER-TO-PEER COMPUTER SYSTEMS

(76) Inventors: Laurent Meynier, Lafayette, CA (US); Charles Marshall, Atherton, CA (US)

Correspondence Address: RICHARD B. MAIN, ESQ.;PATENTS PENDING, 9832 LOIS STILTNER CT., ELK GROVE, CA, 95624, US

(21) Appl. No.: 12/023,017

(22) Filed: Jan. 30, 2008

Related U.S. Application Data
(63) Continuation-in-part of application No. 60/898,618, filed on Jan. 31, 2007.

(51) Int. Cl. G06F 17/30

(52) U.S. Cl. 707/3; 707/E17.108

(57) ABSTRACT

A viral application program for peer-to-peer networking, includes a self-installable application program for emailing or downloading over the Internet. Such includes processes to build an enrollment mechanism for including a plurality of user computers each with their own private document files, and interconnectable over a network. Also, a permissions list associated with each one of the plurality of user computers describes which other user computers have permission to access particular ones of the private document files. And, a mini-index of the private document files is maintained on a corresponding one of the user computers for returning relevant search results for its particular collection of permitted document files. Then, a search accumulator spanning all the mini-indexes can assemble a final search result of all user computers belonging to a particular group.

### RELATED APPLICATIONS

This application claims benefit of U.S. Provisional Patent Application titled, Method and Apparatus for Searching Documents on One or More Computer Systems, Ser. No. 60/898,618, filed Jan. 31, 2007 by Laurent Meynier.

### FIELD OF THE INVENTION

The present invention is related to computer software and more specifically to computer software for searching files on one or more computer systems.

### BACKGROUND OF THE INVENTION

Many users have a large number of files on their computer systems. When the user wishes to find a file on the user's computer system, the user can type one or more keywords into a searching program and receive the file names of files that are related to those keywords, for example, because the contents of the files contain the keywords or the file name contains one or more of the keywords.

When keyword searching is used, the files are not usually ordered according to their relevance to the user.

The files can be ordered in accordance with how many times the keywords appear in the file or other similar orderings, but such orderings rarely correspond to the actual relevance of the file to the user. The problem is compounded when a user searches files of multiple people, such as that user and other users in a work group.

Sometimes, the user performing the search does not wish to see search results that are ordered by relevance of the file to that user, because the user is searching for a file that normally would have little relevance to the searching user, but may have more relevance to another user. For example, if a manager is searching for a file of a user who is on vacation, the manager may wish to locate files that are relevant to the user on vacation, not the manager. Similarly, if the user is searching for files of multiple users, the user performing the search may wish to see the files most relevant to all the users whose files are being searched.

Some users may not wish to make all of their files available to other users for searching. Thus, it would be desirable for any solution to allow the creator or editor of the file to control the parties that will have access to the file, for searching or otherwise.

What is needed is a system and method that can provide results of searched files in an order that is relevant to the user, another user, or multiple users, and that allows an owner of a file to control access to searching that file.

### SUMMARY OF INVENTION

A system and method allows a user to search for files, and then returns the list of files searched in order of relevance to that user, another user, or multiple users. Each file is assigned a relevance score based on factors that correspond to what was done with each file, and the relevance scores may be computed from the perspectives of one or more users different from the user performing the search, either instead of, or in addition to, the perspective of the user performing the search. The files are displayed in accordance with the relevance score, such as in descending order One such relevance factor is whether the file corresponds to any keywords supplied with the search, and the factor is increased based on the number of times the words appear in the file or file name, and the formatting of those words in the file name.

Other relevance factors can be applied to those files that have a keyword factor greater than zero. The factors can include: the number of times the user from whose perspective the file is being addressed has opened the file, the age of those file openings, an amount of time the file was worked on, the age of each such working, whether the file has been tagged by the user corresponding to the perspective, the age of the tagging, the number of files also having been tagged with the same tag by that user, the number of other users who tagged the file, the number of other users who used the same tag when doing so, whether the file or a related file has been sent as an attachment, and whether the file has been used to perform a special function such as creating a PDF-format file from the file.

The factors can be computed from the perspectives of various individuals, who may be specified, or may be identified via other actions, such as individuals the user has recently sent e-mails to, or received e-mails from.

In one aspect of the present invention, a viral application program provides for peer-to-peer networking, and includes a self-installable application program for emailing or downloading over the Internet. Such includes processes to build an enrollment mechanism for including a plurality of user computers each with their own private document files, and interconnectable over a network. Also, a permissions list associated with each one of the plurality of user computers describes which other user computers have permission to access particular ones of the private document files. And, a mini-index of the private document files is maintained on a corresponding one of the user computers for returning relevant search results for its particular collection of permitted document files. Then, a search accumulator spanning all the mini-indexes can assemble a final search result of all user computers belonging to a particular group.

### BRIEF DESCRIPTION OF THE DRAWINGS

FIG. 1 is a block diagram of a single computer system;

FIGS. 2, 3A, 3B, 4A, and 4B, are flowchart diagrams illustrating methods of searching for, and displaying searched files according to embodiments of the present invention;

FIGS. 5 and 6 are functional block diagrams of systems for searching for and displaying searched files according to embodiments of the present invention;

FIG. 7 is a block diagram of a scoring/sort manager of FIG. 6 shown in more detail according to one embodiment of the present invention;

FIG. 8 is a functional block diagram of a network of three computers in communication with one another via the Internet, and each containing the system of FIGS. 5 and 6;

FIG. 9 is a functional block diagram of a peer-to-peer network in which all users have permission to access at least some of the document files for all the other users; and

FIG. 10 is a functional block diagram of a peer-to-peer network in which some users have permission to access at least some of the document files for some of the other users.

### DETAILED DESCRIPTION OF SOME EMBODIMENTS

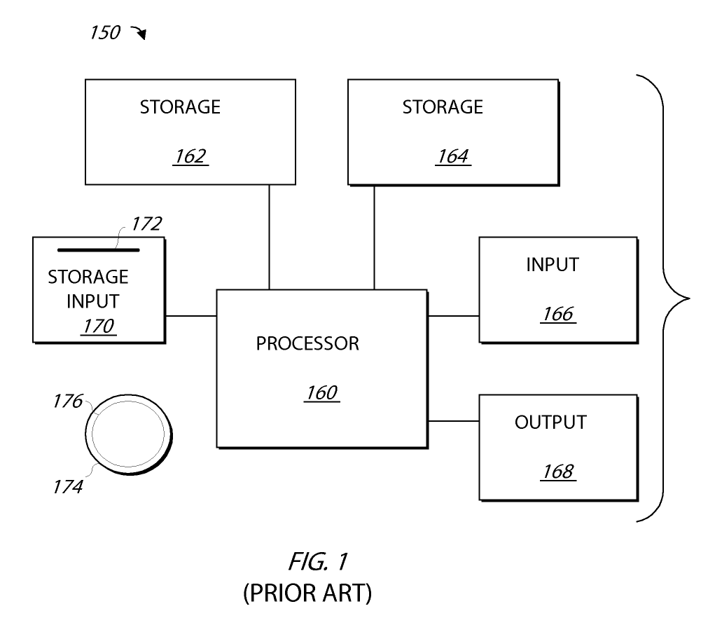

The present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS ULTRA 10 workstation running the SOLARIS operating system commercially available from Sun Microsystems, Inc. (Mountain View, Calif.), a PENTIUM-compatible personal computer system such as are available from Dell Computer (Round Rock, Tex.) running a version of the WINDOWS operating system (such as 95, 98, Me, XP, NT or 2000) commercially available from MICROSOFT (Redmond, Wash.) or a Macintosh computer system running the MACOS or OPENSTEP operating system commercially available from APPLE (Cupertino, Calif.) and the NETSCAPE browser commercially available from Netscape Communications Corporation (Mountain View, Calif.) or INTERNET EXPLORER browser commercially available from MICROSOFT, although other systems may be used.

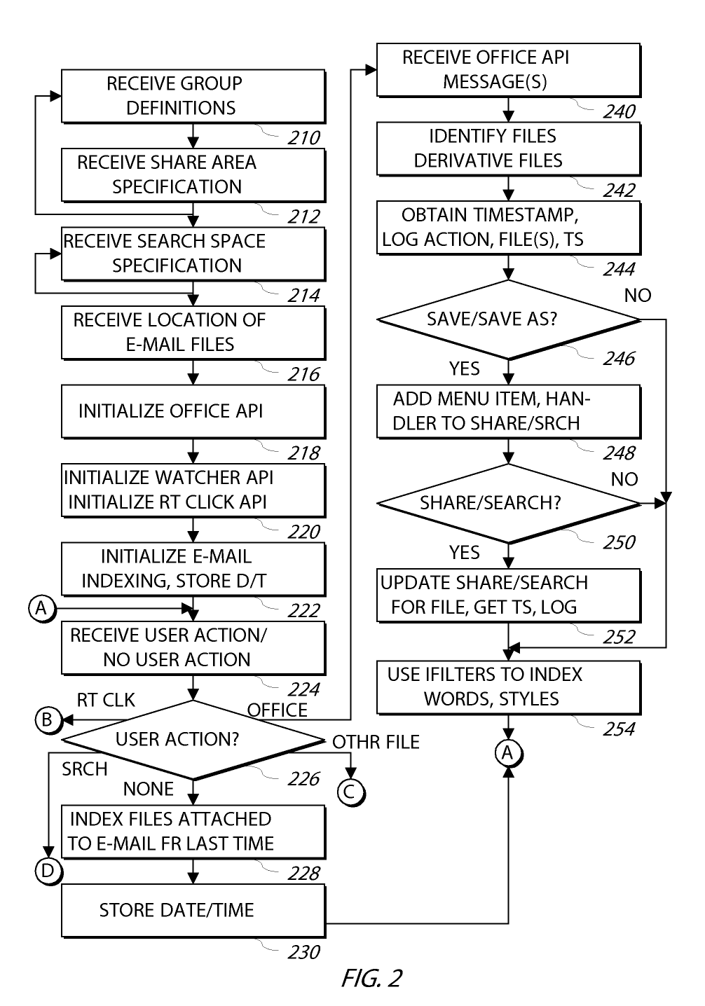

FIGS. 2, 3, and 4 are flowcharts illustrating method embodiments of the present invention for searching, and displaying searched files. Group definitions are received 210, these allow a user to assign to one or more groups the user and other users who may participate with that user for purposes of searching as described in more detail below. Users may be defined by listing a nickname for the user and one or more e-mail addresses corresponding to the user.

A specification of one or more share areas is received 212. In one embodiment, share areas are areas under the control of the user, for example drives or subdirectories on the user's computer system, which the user elects to share with other users. The files shared may be defined on a per file or per subdirectory level, and may be shared with individuals or groups according to the definitions received in step 210. Share areas allow a user to control which other users can search, and open, that user's files. A specification of a search space is received 214.

The search space is the area on the user's computer system, as well as on other users' computer systems, that can be searched, unless a different area is specified for the search at the time of the search. In one embodiment, the search space can be changed on a per search basis, but if not otherwise specified, the search space received in step 214 is used as a default. Steps 210, 212, 214 may be repeated any number of times, at any time, to allow those definitions and specifications to be altered at any time.

One or more locations of one or more e-mail files or e-mail programs containing the user's e-mails are received, along with the user names and passwords corresponding to those files or programs 216. The e-mail files may be files containing an inbox, sent items, and/or other folders used to store e-mails sent or received. There may be multiple e-mail systems in use by a user, and thus any number of e-mail files may be specified. In one embodiment, specification of each e-mail file includes the location and name of the file, as well as the e-mail program and type of e-mail program used to open it. In one embodiment, the types of e-mail programs include server-oriented e-mail programs such as some configurations of OUTLOOK or individual-oriented e-mail programs, such as EUDORA.

An office API is initialized 218. The office API allows conventional office programs, such as Microsoft Word, or Excel, to provide information about what the user is doing in those programs, as described in more detail below. The initialization allows the office API to provide such information at such time as it is available. Information about the Office API provided by Microsoft Office may be found at the web site of msdn2.microsoft.com/en-us/library/aa189857(office.10).aspx.

A watcher API, for example the FileSystemWatcher Class, is also initialized 220. The FileSystemWatcher Class is a function of the operating system and provides information about changes to the file structure being made by the user or other programs. The initialization informs the watcher to provide such information at such time as it is available. Information about the FileSystemWatcher Class for Windows XP may be found at the web site of msdn2.microsoft.com/en-us/library/system.io.filesystemwatcher.aspx.

As part of step 220, an API such as the Windows API provided by Microsoft is also initialized to allow the operating system to provide an indication when the user right clicks a file or subdirectory. Information about the Windows API may be found at the web site of http://msdn2.microsoft.com/en-us/library/aa383749.aspx.

E-mail indexing is initialized 222. E-mail indexing involves scanning e-mail files having locations received as described above and storing in a database the names of users to whom messages were sent or received, optionally the text of those messages, and the names of any files that had been attached to incoming or outgoing e-mail messages. In one embodiment, e-mail messages are scanned using an API of the e-mail program that adds messages to the files. The date and time the indexing was performed is stored.

A user action is received 224 and operation of the method of the present invention continues based on the user action. If the user action is to perform an office function using an office programs such as Microsoft Word, 226, the Office API messages are received 240 that describe an action being performed on the file and any derivative files. That file and any derivative files are identified as those being worked on 242. In one embodiment, a derivative file is a file that is referenced by the file on which the user is working. A timestamp is obtained, for example from a conventional operating system, and the action described by the message, the name and location of the file and any derivative files, and a timestamp are logged 244. In one embodiment, all logging as described herein is done in a database for the user, although multiple databases, or other logging techniques, may be used in other embodiments. Other users have their own databases and may be performing similar functions as those described here, and each other user's actions will be logged into a database for that user. In one embodiment, the databases for each user are stored on that user's computer system, but are available to the extent sharing is enabled to other users using conventional peer-to-peer file sharing techniques.

If the action in the office file is save or save-as 246, a dialog box or menu item is added to the office menus that, when clicked, transfers control to a handler to allow the user to specify that the file should be included in those files the user is sharing with other users, or should be included in the search space 248. In one embodiment, dialog box added for a file save function is added for the first file save of that file, or the first file save by that user. Any changes made to the share or search specification of the file is logged with the date and time, file name and action performed, the same or similar format used to log other logging operations described herein. Otherwise 246, the method continues at step 254.

If the user alters the share or search options for the file 250, the share or search information is updated for the file, a timestamp is obtained as described above, the act of updating the share or search information for the file or files is logged in the database 252, and the method continues at step 254. If no share or search information is updated 250, the method continues at step 254.

At step 254, the conventional I-filters program or another program that reads various file formats are then used to index the words and the styles of those words in the file or files. I-filters allows the file to be scanned, words in the file to be extracted, and the style of the words to be identified. For example, a word may be a part of a title, or may be bolded. Those words are stored in a database as part of step 254, along with any styles that correspond to those words in the file. The method continues at step 224.

If no user action is received 224, the e-mail files may be indexed from time to time, from a point in the email files since the last time the e-mail files were indexed 228, and the date and time of such indexing is stored 230. The method continues at step 224.

If at step 224 the user action received is a right click on a file 226, the method continues at step 410. At step 410, tag, search, and share menu items are added to the right-click menu and one of those commands may be received. Other ways of providing a similar user interface may be employed other than right clicks, though the description herein uses the right click menu. If the command is a command to share or stop sharing the file or subdirectory that had been selected at the time the right-click occurred 412, either the file's or subdirectory's status is changed from being shared to not being shared or vice versa as indicated by the command, or a user interface is provided to allow the user to specify the sharing options for the file or subdirectory selected, and the act of changing the sharing options is logged 414. The method continues at step 224 of FIG. 2. In one embodiment, the sharing command is displayed as a function of the current sharing option for the file or subdirectory (if all the files in the directory have the same sharing characteristic) selected at the time the file or subdirectory is right clicked. For example, if the currently selected file is shared, the sharing menu item would be displayed as “unshare” and if the currently selected file is not shared, the menu item would be displayed as “share”. In one embodiment, a drive may be selected as described herein instead of a directory, and the command will apply to the drive selected, and all files and subdirectories therein, instead of applying to the subdirectory selected. Characteristics such as sharing that are set for a subdirectory will apply to all the files in that subdirectory, and all subdirectories contained within the parent subdirectory.

If the command received in step 410 is a command to include the file or subdirectory selected in the default search space 412, a user interface may be provided to allow the file or subdirectory to be included or removed from the search space, and the act of changing the searchable status of the file or subdirectory is logged 416. In one embodiment, if only a file is specified or if all of the files in a subdirectory are of the same status for searching, instead of providing a separate user interface, the menu item added may be a menu item that changes the sharing of the file or subdirectory without the need for a user interface in step 416, in the same manner that the sharing characteristic of a file or of all of the files in a subdirectory were changed as described above. The method continues at step 224 of FIG. 2.

One of the menu items added in step 410 is a menu item to tag a file or all files in a subdirectory. If the user selects that menu item 412 to tag a file or files, a user interface is provided to allow the user to add one or more tags to the selected file(s) 418. As part of step 418, a timestamp is retrieved and the file name and tag or tags added are logged. In one embodiment, the tag or tags may be added to more than one file if more than one file has been selected or if an entire subdirectory has been selected. In such embodiment, a tag or text specified will be added to all such files and the timestamp, tags, and file names for each file to which the tags have been specified are also logged in the database. The method continues at step 224 of FIG. 2.

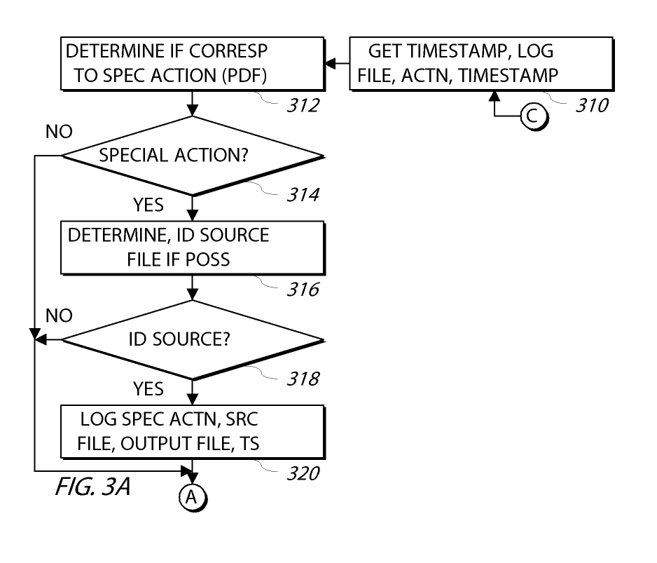

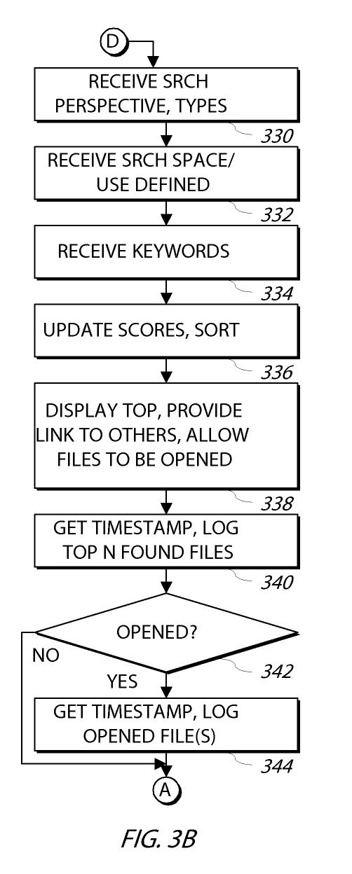

If at step 224 the user action received is another file action 226, the method continues at step 310 of FIG. 3A. Referring now to FIG. 3A, at step 310, a timestamp is retrieved and the name of the file, location of the file, action being performed and the timestamp are logged 310, for example, in the database. An example of an action being performed is a new file being saved. A determination is made as to whether the action corresponds to a special action such as saving a PDF file 312. If the action does not correspond to a special action 314, the method continues at step 224 of FIG. 2. If the action does correspond to a special action 314, a determination is made as to whether identification of the source file of the special action is possible 316. For example, identification of a source file of a PDF file being saved is possible if a file having the same name, but a different extension exists, and optionally if such two files are located in the same subdirectory, or one file is located in a descendant subdirectory of the other file. Another way of determining whether or not identification of the source file is possible is whether a single file is currently open in an office application as logged as described above. If identification of the source is possible, then an identification of the special action, such as creation of a PDF file, as well as the names and locations of the source file and the output file, are logged along with the timestamp 320, and the method continues at step 224 of FIG. 2.

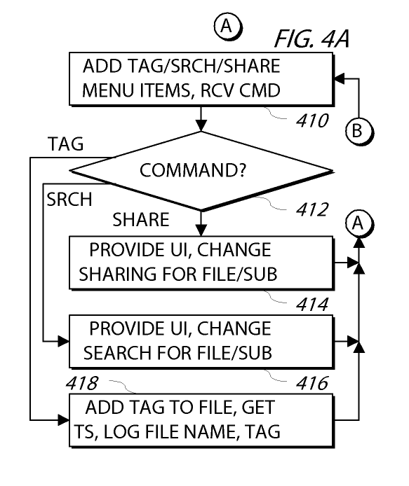

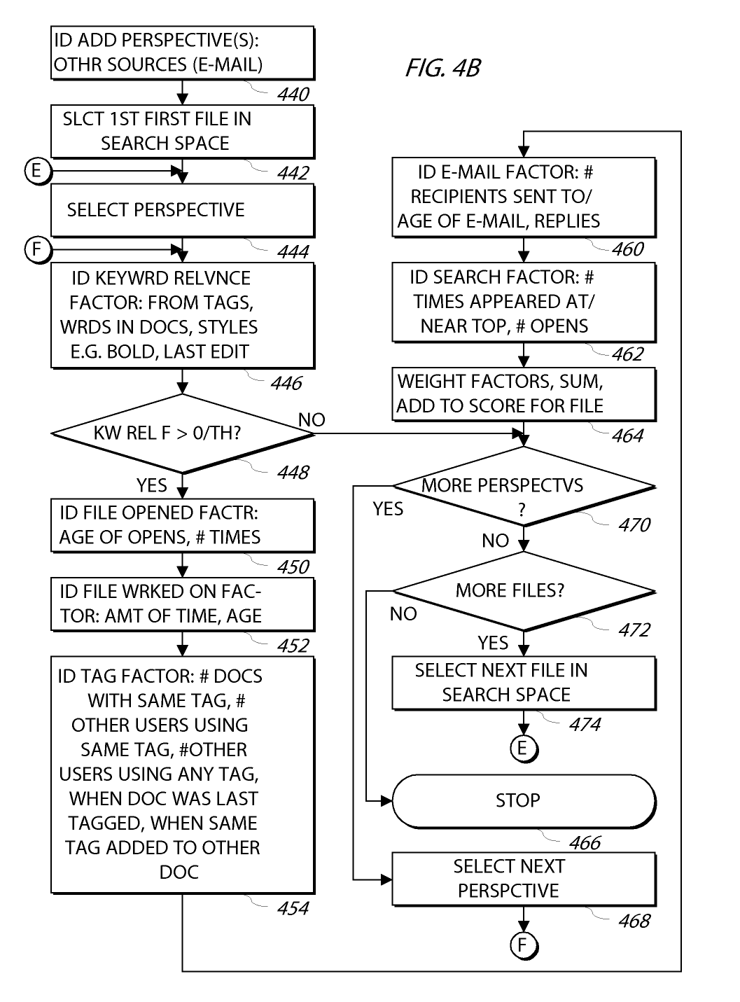

If the user action is a request to perform a search 226, the method continues at step 330 of FIG. 3B. Referring now to FIG. 3B, at step 330, one or more search perspectives are received and any file type limitations are also received. A search perspective corresponds to an identifier of the user from whose perspective the search is to be performed, and there may be any number of such users specified, with the default being the user performing the search. A new search space may be optionally received 332, or the search space defined as described above may be used instead. Keywords corresponding to the search may be received 334. Scores corresponding to the files corresponding to the search space are updated, and the file names and locations of such files are sorted 336 in descending order of their scores, as described in more detail with reference to FIG. 4. The file names and locations having the top scores are displayed in descending order of the scores, and any number of links may be provided to allow the display of other lower scoring files 338, with the file names being displayed in descending order of the scores. Other orders may be used if the display order is based on the order of the score of the displayed filenames.

The user can click on the file names displayed to open any of them, or click on the link or links until the correct file is located, and then the file names may be clicked on to open them using the applications defined for that type of file. A timestamp is retrieved and the top one or more found files are logged 340. If any of the files are opened 342, a timestamp is retrieved and the fact that the files were opened as a result of being found in a search is also logged 344. The method continues at step 324 of FIG. 2. If the files are not opened 342, the method continues at step 224 of FIG. 2.

FIG. 4B illustrates a method of updating scores as described above with reference to FIG. 3B, step 336. Based on the perspectives specified by the user (or using the perspective of the user performing the search), one or more additional perspectives may be identified from other sources 440, for example by identifying other users with which the user or users corresponding to the specified perspectives interact. In one embodiment, such interaction is identified from sources such as e-mail. In one embodiment, additional perspectives are those of users with whom the users corresponding to the specified perspectives have had recent or otherwise significant communications, e.g., by e-mail. Significant communications may for example be identified by the number of e-mails sent in a recent period of time, the number of other addressees on such e-mails, and whether any attachments were sent. Such information may be stored as part of steps 222 and 228-230. The first file in the search space is selected 442, and the first perspective (specified or additional) is selected 444.

A keyword relevance factor is identified 446 for the selected file using the keywords specified as described above, based on how significant the keywords are to that file. The significance of the keywords to the file may be determined based on characteristics such as: whether or not the keywords match or otherwise correspond to tags associated with the file, with such correspondence identified e.g., by using a conventional dictionary or thesaurus; whether the keywords match or correspond to words in the document corresponding to the file; and whether there are styles associated with such words, such as whether or not a word is in bold or a word was most recently added to the file. In one embodiment each of these characteristics may correspond to a different multiplier, so that the keyword relevance factor is determined based on each of these characteristics of the file, with each characteristic being weighted differently. The portion corresponding to the actual contents of the file may only be calculated for the first perspective so that it is not weighted disproportionately.

If the keyword relevance factor is not greater than zero or another threshold 448, the method continues at step 470. Otherwise 448, a file open factor is identified 450. In one embodiment, the file open factor is a function of the number of times the file was opened, and the age of each of those opens, with older opens having less of an influence on the file open factor.

A file worked on factor is identified 452. In one embodiment, the file worked on factor is a function of the amount of time that file has recently been worked on, and the age at which the worked on times appeared in the database.

A tag factor is identified 454. In one embodiment, the tag factor is a function of characteristics such as: the number of documents to which the user corresponding to the selected perspective assigned the same tag or tags as the selected document; the number of other users using the same tag for that document; and the number of other users using any tag corresponding to that document, with each of these tags being those specified by the user corresponding to the current perspective. In one embodiment, the portion of the tag factor corresponding to these other users using any tag is only calculated for the first perspective, so that it is not counted each time a different perspective is used. Other contributions to the tag factor may include: when the document was last tagged by the user corresponding to the perspective, and when the same tag was added to another document by the user corresponding to the perspective.

An e-mail factor is identified 460. In one embodiment, the e-mail factor corresponds to the number of recipients that the selected file was sent to, or received from (using the selected perspective, which corresponds to a user), weighted by the age of each e-mail, with the older e-mails having a lower weight. The e-mail factor may also be a function of any replies sent to such e-mails, such replies being identified as those that have the same subject field, with optionally the additional word “re:”, “fwd” or variants thereof, any number of times.

A search factor is identified 462. In one embodiment, the search factor is a function of the number of times the file appeared at or near the top of a search performed by the user corresponding to the selected perspective, whether the user opened the file from the search results, and the age of that search.

The factors described above may be weighted and added to any other factors for the same file to produce a score for the user corresponding to the perspective, and that score is added to any other score produced for the same file for other perspectives 464. If there are more perspectives 470, including either specified perspectives or added perspectives, the next perspective is selected 468, and the method continues at step 446 using the newly selected perspective. Otherwise 470, if there are more files 472, the next file in the search space is selected 474 and the method continues at step 444. If there are no more files 472, the method of computing factors is complete 466.

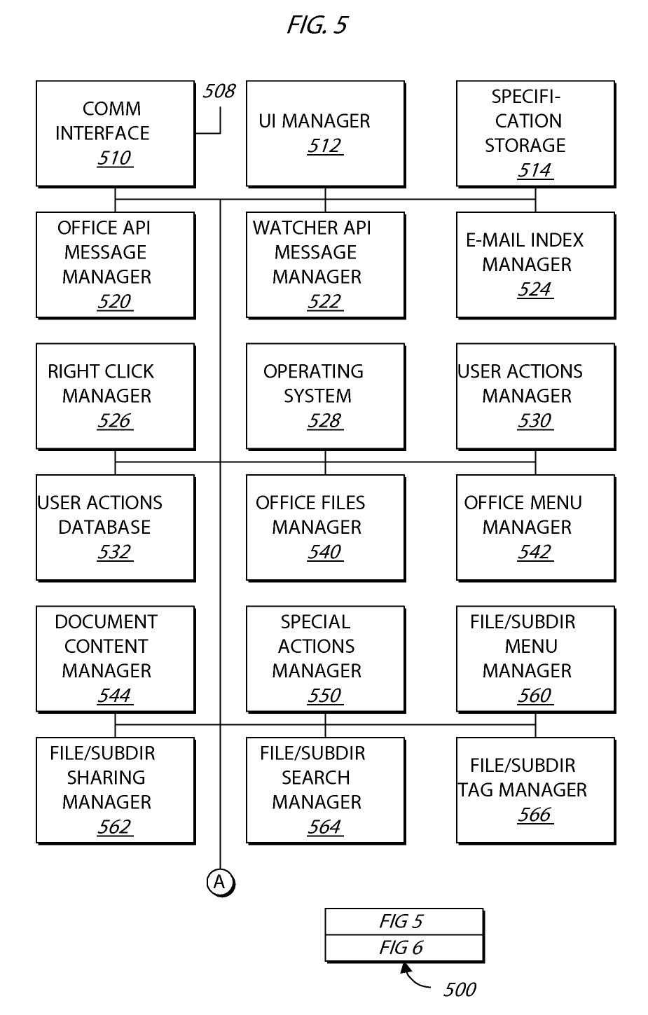

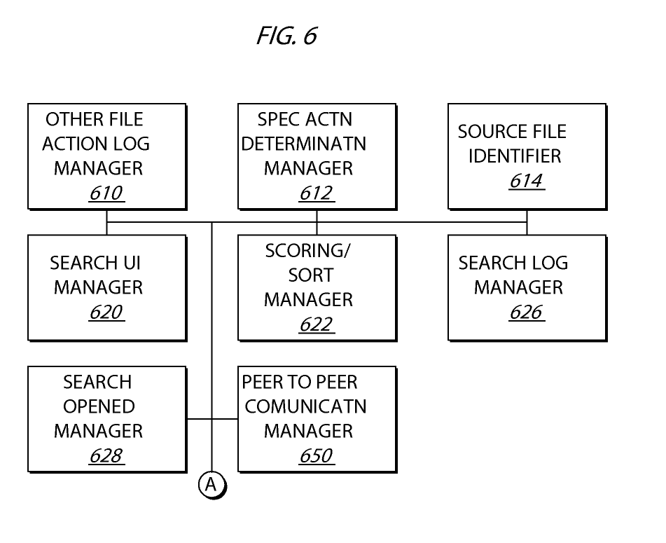

FIGS. 5 and 6 together illustrate a system 500 for displaying searched files according to one embodiment of the present invention. System 500 includes all of the elements shown in both FIGS. 5 and 6. Users may request a user interface from user interface manager 512, for example via input/output 508 of communication interface 510. Communications interface 510 is a TCP/IP-capable communication interface coupled to the Internet or a local area network.

When user interface manager 512 receives a request, user interface manager 512 provides a user interface, and the user employs that user interface for providing one or more group definitions, one or more share area specifications, a search space specification, and the location of e-mail files, as described above with respect to steps 210-216. User interface manager 512 receives this information and stores it in specification storage 514. In one embodiment, specification storage 514 includes a conventional database. When user interface manager 512 has stored the one or more group definitions, one or more share area specifications, the search space specification, and the location of e-mail files in specification storage 514, user interface manager 512 signals office API message manager 520, watcher API message manager 522, e-mail index manager 524, and right click manager 526.

When so signaled, office API message manager 520 initializes a conventional API allowing conventional office programs, such as Microsoft Word, or Excel, to provide information about what the user is doing in those programs, such as when a user right clicks such a file or performs an action such as saving the file. Office API message manager 520 may receive such information from such conventional office programs at any time after initialization. When office API message manager 520 receives such information, office API message manager 520 provides the information to user actions manager 530, which proceeds as described below.

When watcher API message manager 522 is signaled by user interface manager 512 as described above, watcher API message manager 522 initializes a conventional API allowing operating system 528 to provide information about changes to the file structure being made by the user or other programs. In one embodiment, operating system 528 is a conventional operating system such as the commercially available WINDOWS system. Watcher API message manager 522 may receive such information from operating system 528 at any time after performing such initialization. When watcher API message manager 522 receives such information, watcher API message manager 522 provides the information to other file action log manager 610, which proceeds as described below. When e-mail index manager 524 is signaled by user interface manager 512 as described above, e-mail index manager 524 finds the e-mail file locations stored in specification storage 514, scans such files, and locates the names of users to whom messages were sent or received, as well as, optionally, the text of those messages, and the names of any files that had been attached to incoming or outgoing e-mail messages. In one embodiment, to do so, email index manager 524 uses a conventional API associated with the e-mail program that adds messages to the files, such as the Eudora Extended Message Services API or the Microsoft Windows Messaging Application Programming Interface, described at msdn.microsoft.com/library/default.asp?url=/library/en-us/exchanchor/htms/msexchsvr_mapi.asp.

E-mail index manager 524 stores this e-mail information in user actions database 532, and also stores the date and time that the email indexing was performed, which e-mail index manager 524 may for example request and receive from operating system 528.

When right click manager 526 is signaled by user interface manager 512 as described above, right click manager 526 initializes a conventional operating system API, allowing operating system 528 to provide an indication when a user right clicks on a file, drive, or subdirectory. Right click manager 526 may receive such an indication from operating system 528 at any time after performing such initialization. In one embodiment, the indication is associated with an identifier of the file, drive, or subdirectory that was right clicked by the user. When right click manager 526 receives this information, right click manager 526 provides the indication and identifier to user actions manager 530, which proceeds as described below.

When user actions manager 530 receives information about user actions in office files from office API message manager 520 as described above, user actions manager 530 provides the information received to office files manager 540. In one embodiment, such information includes an identifier of the file in which the user is working; identifiers of any derivative files referenced by that file; and an indication of the action taken by the user, such as opening the file, modifying the file, saving the file, or closing the file. In one embodiment, file identifiers include a file name and the location of the file, such as the path of the file and an identifier such as the network name and/or IP address of the user system in which the file is located. User actions manager 530 also proceeds as described below.

When office files manager 540 receives the information, office files manager 540 requests and receives a timestamp from operating system 528. Office files manager 540 saves the file identifiers and action indication in user actions database 532, associated with the timestamp.

In addition to providing the information to office files manager 540 as described above, user actions manager 530 also determines whether the user action taken was to save a file. If the user action was to save a file, office files manager 540 provides the identifier of the file that was saved to document content manager 544, which proceeds as described herein and below. Office files manager 540 also checks any previous action indications associated with that file identifier in user actions database 532, in order to determine whether the file has been previously saved. In one embodiment, if the file has not been previously saved, office files manager 540 provides the identifier of the file that was saved, along with the identifiers of all derivative files referenced by that file, to office menu manager 542, and otherwise office files manager 540 provides an indication to the conventional office program via the conventional office API that the save should proceed normally.

When office menu manager 542 receives the file identifier(s) from user actions manager 530 as described above, office menu manager 542 adds a menu item, via the conventional office API, to the save/save as dialog box, allowing the user to change the searchable or sharable status of the file. If selected by the user, the menu item provides office menu manager 542 with an indication that the menu item has been selected, in one embodiment along with the file identifier and the identifiers of any derivative files.

When office menu manager 542 receives the menu item indication and file identifier(s), office menu manager 542 uses the information stored in specification storage 514 to determine whether the file is included in any of the share areas or in the search space defined by the specifications in specification storage 514. If the file is included in any of the share areas defined by the specifications in specification storage 514, office menu manager 542 provides a user interface to the user indicating in which share area the file is included, if any, and allowing the user to remove that file from the share area and/or to include it in one or more of the share areas. The user interface also indicates whether the file is included in the search space, and allows the user to remove the file from or add it to the search space. If the user indicates via the user interface that the searchable and/or sharable status of the file should be changed, office menu manager 542 modifies the corresponding search space and/or share area specification(s) in specification storage 514 to include or exclude the file. In one embodiment, office menu manager 542 also modifies the specification(s) to include or exclude any derivative files of that file.

Office menu manager 542 also requests and receives a timestamp, for example from operating system 528, and stores the timestamp, along with the file identifier and an indication that the share and/or search information for the file was changed, in user actions database 532. In one embodiment, user actions database 532 includes a conventional database.

When document content manager 544 receives the file identifier(s) from office files manager 540, document content manager 544 uses the conventional I-filters program, or another program that reads various file formats, to extract the words and the styles of those words in the identified file or files, I-filters scans the file, extracts words in the file, and identifies the style of such words to be identified. For example, a word may be a part of a title, or may be bolded. Document content manager 544 stores any extracted words and corresponding styles in user actions database 532, associated with the file identifier of the file from which such words were extracted.

Although in this embodiment, document content manager 544 receives the file identifier(s) of saved files from office files manager 540, in another embodiment watcher API message manager 522 may additionally or alternatively provide document content manager 544 with the file identifier of any file that is saved in system 500, and document content manager 544 may proceed to index that file, at that time, at any time, user actions manager 530 may receive from right click manager 526 an indication that the user right clicked on a file, drive, or subdirectory, along with an identifier of the file, drive, or subdirectory. When user actions manager 530 receives the indication and identifier, user actions manager 530 provides the indication and identifier to file/subdirectory menu manager 560. When file/subdirectory menu manager 560 receives the indication and identifier, file/subdirectory menu manager 560 adds menu items, via the conventional operating system API, to the file, drive, or subdirectory right clicked by the user. The menu items allow the user to request to change the sharable status of the file, drive, or subdirectory; to change the searchable status of the file, drive, or subdirectory; or to add a tag to the file, drive, or subdirectory.

If the user uses the menu item to request to change the sharable status of the file, drive, or subdirectory, file/subdirectory menu manager 560 provides the identifier of the file, drive, or subdirectory to file/subdirectory sharing manager 562. If the user uses the menu item to request to change the searchable status of the file, drive, or subdirectory, file/subdirectory menu manager 560 provides the identifier of the file, drive, or subdirectory to file/subdirectory search manager 564. If the user uses the menu item to request to add a tag to the file, drive, or subdirectory, file/subdirectory menu manager 560 provides the identifier of the file, drive, or subdirectory to file/subdirectory tag manager 566. File/subdirectory sharing manager 562, file/subdirectory search manager 564, and file/subdirectory tag manager 566 proceed as described herein and below.

When file/subdirectory sharing manager 562 receives the identifier, file/subdirectory sharing manager 562 uses the information stored in specification storage 514 to determine whether the file, drive, or subdirectory is included in any of the share areas defined by the specifications in specification storage 514. File/subdirectory sharing manager 562 provides a user interface to the user indicating in which share area the file, drive, or subdirectory is included, if any, and allowing the user to remove that file, drive, or subdirectory from the share area and/or to include it in one or more of the share areas. If the user indicates via the user interface that the file, drive, or subdirectory should be removed from and/or added to a share area, file/subdirectory sharing manager 562 modifies the corresponding share area specification(s) in specification storage 514 to include or exclude the file, drive, or subdirectory. In one embodiment, file/subdirectory sharing manager 562 also modifies the specification(s) to include or exclude any derivative files of that file, or any files and subdirectories included in that drive or subdirectory.

File/subdirectory sharing manager 562 also requests and receives a timestamp, for example from operating system 528, and stores the timestamp, along with the identifiers of all files affected by the change, in user actions database 532. File/subdirectory sharing manager 562 also stores an indication associated with each file identifier that the sharable status of the file was changed.

When file/subdirectory search manager 564 receives the file, drive, or subdirectory identifier from file/subdirectory menu manager 560, file/subdirectory search manager 564 uses the information stored in specification storage 514 to determine whether the file, drive, or subdirectory is included in any the search spaces defined by the search space specification in specification storage 514. File/subdirectory search manager 564 provides a user interface to the user indicating whether the file is currently included in the search space, and allowing the user to remove the file, drive, or subdirectory from, or add it to, the search space. If the user indicates via the user interface that the file, drive, or subdirectory should be removed from or added to the search space, file/subdirectory search manager 564 modifies the search space specification in specification storage 514 to exclude or include the file, drive, or subdirectory, according to the user's indication. In one embodiment, file/subdirectory search manager 564 also modifies the specification to include or exclude any derivative files of that file, or any files and subdirectories included in that drive or subdirectory.

File/subdirectory search manager 564 also requests and receives a timestamp, for example from operating system 528, and stores the timestamp, along with the identifiers of all files affected by the change, in user actions database 532. File/subdirectory search manager 564 also stores an indication associated with each file identifier that the searchable status of the file was changed.

When file/subdirectory tag manager 566 receives the file, drive, or subdirectory identifier from file/subdirectory menu manager 560, file/subdirectory tag manager 566 uses the information stored in user actions database 532 to determine whether any tags are already associated with that file, drive, or subdirectory. File/subdirectory tag manager 566 provides a user interface to the user showing any tags currently associated with the indicated file, drive, or subdirectory, and allowing the user to add new tags and/or delete or modify any existing tags. If the user provides any changes to the tags via the user interface, file/subdirectory tag manager 566 stores the file, drive, or subdirectory identifier, along with the tags received from the user, in user actions database 532, replacing any previously stored tag information for that file, drive, or subdirectory identifier. File/subdirectory search manager 564 also requests and receives a timestamp from operating system 528, and stores the timestamp, along with an indication that the tag information was changed, in user actions database 532, associated with the file, drive, or subdirectory identifier.

File action log manager 610 may receive information about changes to the file structure being made by the user or other programs from watcher API message manager 522. In one embodiment, the information includes identifier(s) of the file(s) affected by the change, along with an indication of the nature of the change, such as deletion or addition of files. When other file action log manager 610 receives such information, other file action log manager 610 requests and receives a timestamp from operating system 528 and stores the timestamp, identifiers, and indication received in user actions database 532. Other file action log manager 610 also provides the identifiers and indication to special action determination manager 612.

When special action determination manager 612 receives such information, special action determination manager 612 determines whether the information received corresponds to a special action such as the addition of a new PDF file. If not, in one embodiment, special action determination manager 612 discards the information. Otherwise, special action determination manager 612 provides the information to source file identifier 614. When source file identifier 614 receives such information, source file identifier 614 attempts to identify the source file of the special action. For example, source file identifier 614 may attempt to identify the source file of a PDF file being saved by searching for a file with the same name as a new PDF file but a different extension, optionally in the same subdirectory or path as the new PDF file. Additionally or alternatively, source file identifier 614 may use the information in user actions database 532 to determine whether a single file is currently open in an office application, and may determine that any such file is the source file of the special action. In one embodiment, if source file identifier 614 is unable to identify the source file of the special action, source file identifier 614 discards the information received. Otherwise, source file identifier 614 stores the indication of the special action, the identifier of the output file (for example the new PDF file) the identifier of the source file, and a timestamp, which source file identifier 614 may for example request and receive from operating system 528, in user actions database 532.

At any time, the user may request and receive a user interface for performing a search from search user interface manager 620. The user interface allows the user to provide search parameters. In one embodiment, search parameters include one or more keywords for the search, as well as, optionally, the file types to which the search should be limited. In one embodiment, search parameters also include one or more search perspectives, which as described herein may be the perspective of the user performing the search and/or may include one or more other user's perspectives. In one embodiment, the user interface allows the user to select from all other users known to system 500 the users from whose perspective the search should be performed. To display the list of known users, search interface manager 620 may for example request and receive from peer to peer communication manager 650 a list of all users known to system 500 and identifiers, such as the IP address or network name, of the user systems associated with those users. In one embodiment, peer to peer communication manager 650 includes a conventional peer to peer interface subsystem that allows location and communication with other user systems. In this embodiment, if the user selects any users from whose perspective the search should be performed, for each such user, search interface manager 620 includes in the search parameters a perspective identifier that in one embodiment corresponds to an identifier of the user system associated with that user.

The user interface also allows the user to also optionally specify a search space as part of the search parameters, and in one embodiment if the user does not do so, search user interface manager 620 finds the search space specified in specification storage 514 and includes that search space in the search parameters. When search user interface manager 620 has received and/or identified the search parameters, search user interface manager 620 provides the search parameters to scoring/sort manager 622.

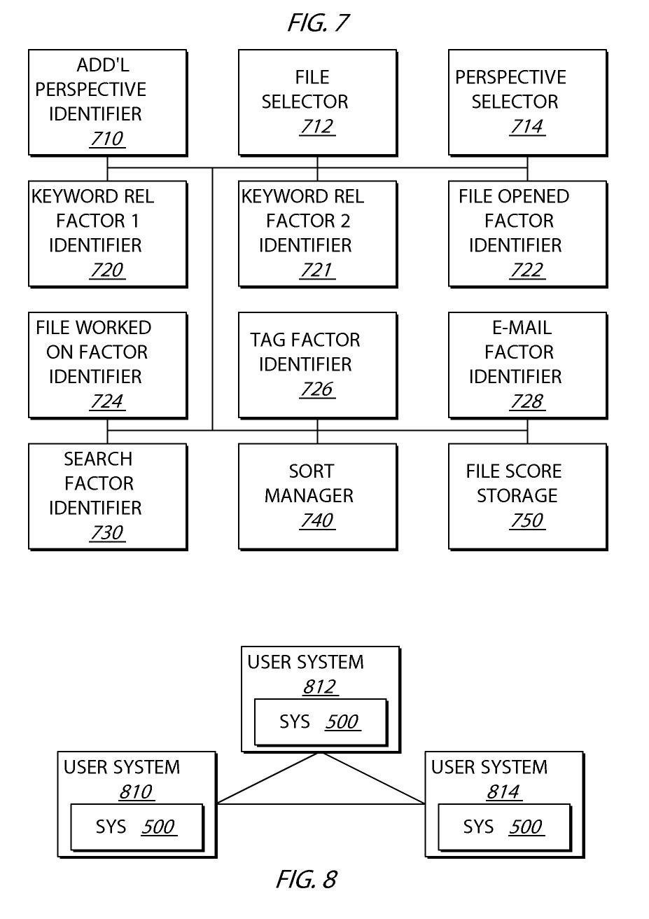

When scoring/sort manager 622 receives the search parameters, scoring/sort manager 622 computes scores for each file included in the search space, and sorts the files in descending order of their scores, as described in more detail herein and below with reference to FIG. 7. Scoring/sort manager 622 provides a list of the file identifiers and the associated scores of those files, in the sorted order, to search UI manager 620, and also provides up to a predetermined number of the file identifiers, such the first ten file identifiers, or all the file identifiers if the number of files in the search space is less than the predetermined number, to search log manager 626, which proceeds as described below.

When search UI manager 620 receives the sorted list of file identifiers and associated scores, search UI manager 620 provides a user interface to the user displaying the top scoring file names and the locations of those files, for example, the top scoring three file names and locations, in one embodiment, each file identifier includes the file name and the location of the file. In one embodiment, search UI manager 620 displays such files in descending order of the scores, and optionally displays the scores. The user interface also allows the user to display the lower scoring file names and locations by clicking on one or more links, buttons or other controls, and to open any of the files by clicking on the file names displayed. When the user does so, search UI manager 620 opens the file by directing the operating system to launch the application defined for that type of file, for example using operating system 528. When the user opens a file, search UI manager 620 provides the identifier of that file to search opened manager 628.

When search opened manager 628 receives the file identifier, search opened manager 628 requests and receives a timestamp from operating system 528, and stores the timestamp and file identifier, along with an indication that the file was opened as a result of being found in a search, in user actions database 532.

When search log manager 626 receives the file identifiers from scoring/sort manager 622, search log manager 626 requests and receives a timestamp from operating system 528, and stores the timestamp and file identifiers, along with an indication that the files were found in a search, in user actions database 532.

FIG. 7 shows the scoring/sort manager of FIG. 6 in more detail, according to one embodiment of the present invention. FIG. 8 shows user systems 810, 812, and 814 connected via a network such as the Internet in a peer-to-peer architecture, according to one embodiment of the present invention. Although three user systems 810, 812, and 814 are shown as part of FIG. 8, any number of user systems may be incorporated in other embodiments. Each user system 810, 812, 814 contains system 500, including all of the elements of FIGS. 5 and 6.

Referring now to FIGS. 6, 7, and 8, when scoring/sort manager 622 receives the search parameters, the search parameters are received by additional perspective identifier 710 of scoring/sort manager 622. When additional perspective identifier 710 receives the search parameters, additional perspective identifier 710 optionally uses the e-mail information stored in user actions database 532 by e-mail index manager 524, to identify additional search perspectives, with respect to step 440. Additional perspective identifier 710 stores the search parameters and perspective identifiers of any additional search perspectives so identified in file score storage 750, in one embodiment replacing any previously stored information. Additional perspective identifier 710 also signals file selector 712.

When so signaled, file selector 712 finds the search space defined as part of the search parameters stored in file score storage 750, and selects the first file in that search space. File selector 712 provides an identifier of the selected file to keyword relevance Factor-1 identifier 720. The file may be a local file, located within the same user system in which file selector 712 is located, e.g., user system 810, or may be a remote file, for example located within another user system such as user system 812 or 814.

When keyword relevance Factor-1 identifier 720 receives the file identifier, keyword relevance Factor-1 identifier 720 finds the one or more keywords stored as part of the search parameters in file score storage 750. Keyword relevance Factor-1 identifier 720 uses the keywords to compute or obtains a first part of a keyword relevance factor for the selected file. To do so, if the file identifier indicates that the file is located in the user system in which keyword relevance Factor-1 identifier 720 is also located, such as user system 810, keyword relevance Factor-1 identifier 720 compares the keywords to any document word and style information associated with that file identifier in user actions database 532, for example stored by document content manager 544. Keyword relevance Factor-1 identifier 720 uses this information to compute the first portion of the keyword relevance factor as a factor of characteristics such as whether the keywords match or correspond to words in the document corresponding to the file, with such correspondence identified e.g., by using a conventional dictionary or thesaurus, and whether there are styles associated with such words, such as whether or not a word is in bold or a word was most recently added to the file, with reference to step 446. If the file identifier indicates that the file is located in another user system, e.g., user system 812, keyword relevance Factor-1 identifier 720 provides the file identifier and the keywords to the corresponding keyword relevance Factor-1 identifier 720 of that user system 812, associated with an indication that the first part of the keyword relevance factor should be computed for that file and returned to the originating keyword relevance Factor-1 identifier 720 of user system 810. The originating keyword relevance Factor-1 identifier 720 of user system 810 may for example provide such information via peer to peer communication manager 650.

When the keyword relevance Factor-1 identifier 720 of user system 812 receives the file identifier, keywords, and associated indication, keyword relevance Factor-1 identifier 720 computes the first part of the keyword relevance factor for the identified file, using the information stored in user actions database 532 of user system 812 by document content manager 544 of user system 812, and returns the computed first part of the keyword relevance factor to the originating keyword relevance Factor-1 identifier 720 of user system 810, via peer to peer communication manager 650. Similarly, at any time, keyword relevance Factor-1 identifier 720 of user system 810 may receive a file identifier from the keyword relevance Factor-1 identifier 720 of another user system such as user system 814, associated with one or more keywords and an indication that the first part of the keyword relevance factor should be computed for that file and returned to the keyword relevance Factor-1 identifier 720 of user system 814. When keyword relevance Factor-1 identifier 720 of user system 810 receives the identifier, keywords, and indication, keyword relevance Factor-1 identifier 720 of user system 810 computes the first part of the keyword relevance factor for the identified file, and returns that information to the keyword relevance Factor-1 identifier 720 of user system 814. In this fashion, keyword relevance Factor-1 identifier 720 of any user system may compute or obtain a first part of the keyword relevance factor for a selected file located on any user system. When keyword relevance Factor-1 identifier 720 has computed or obtained the first part of the keyword relevance factor for the selected file, keyword relevance Factor-1 identifier 720 stores the first part of the keyword relevance factor, associated with the file identifier, in file score storage 750. Keyword relevance Factor-1 identifier 720 also provides the file identifier to perspective selector 714.

When perspective selector 714 receives the file identifier, perspective selector 714 selects the first of the search perspectives stored in file score storage 750, where the search perspectives include both any search perspectives supplied by the user as part of the search parameters, and any additional search perspectives identified by additional perspective identifier 710. Perspective selector 714 provides the file identifier and an identifier of the selected search perspective (which may be the identifier of any user, such as that user's name) to keyword relevance Factor-2 identifier 721. Perspective selector 714 also retains the file identifier for use.

When keyword relevance Factor-2 identifier 721 receives the file identifier and perspective identifier, keyword relevance Factor-2 identifier 721 uses the one or more keywords stored as part of the search parameters in file score storage 750 to compute or obtain a second portion of the keyword factor for the selected file and perspective. To do so, if the perspective identifier indicates that the perspective is that of a user corresponding to the user system in which keyword relevance Factor-2 identifier 721 is located, such as user system 810, keyword relevance Factor-2 identifier 721 compares the keywords to any tag information stored associated with the file identifier in user actions database 532, for example by file/subdirectory tag manager 566. In one embodiment, the second portion of the keyword factor is a function of whether or not the keywords match or otherwise correspond to tags associated with the file.

If the perspective identifier indicates that the perspective is that of a user corresponding to a user system other than the user system in which keyword relevance Factor-2 identifier 721 is located, such as user system 812 or user system 814, keyword relevance Factor-2 identifier 721 provides the file identifier and the keywords to the keyword relevance Factor-2 identifier 721 of the user system corresponding to the perspective identifier, e.g., user system 814, via peer to peer communication manager 650, along with an indication that the second part of the keyword relevance factor should be computed for that file and returned to the originating keyword relevance Factor-2 identifier 721 of user system 810. The receiving keyword relevance Factor-2 identifier 721 of user system 814 computes the second part of the keyword relevance factor as described above, using the keywords and any tag information stored associated with the received file identifier in user actions database 532 of user system 814, and returns the computed second part of the keyword relevance factor to the originating keyword relevance Factor-2 identifier 721 of user system 810 via peer to peer communication manager 650. Similarly, at any time, keyword relevance Factor-2 identifier 721 of user system 810 may receive a file identifier, keywords, and indication from the keyword relevance Factor-2 identifier 721 of another user system 812, 814, and may accordingly compute and return the second part of the keyword relevance factor for that file as described herein.

When keyword relevance Factor-2 identifier 721 has computed or obtained the second part of the keyword relevance factor for the selected file and perspective, keyword relevance Factor-2 identifier 721 computes the complete keyword file relevance factor for the selected file and perspective, using the second part of the keyword relevance factor as well as the first part of the keyword relevance factor that was stored in file storage 750 as described above. Keyword relevance Factor-2 identifier 721 may weight the two parts differently. When keyword relevance Factor-2 identifier 721 has computed the complete keyword relevance factor for the selected file and perspective, if the complete keyword relevance factor is not greater than a predetermined threshold such as zero, keyword relevance Factor-2 identifier 721 signals perspective selector 714, which proceeds as described herein and below. Otherwise, keyword relevance Factor-2 identifier 721 stores the complete keyword relevance factor, associated with the file identifier and the perspective identifier, in file score storage 750, and also provides the file identifier and the perspective identifier to file opened factor identifier 722.

When file opened factor identifier 722 receives the file identifier and the perspective identifier, file opened factor identifier 722 computes or obtains a file opened factor for the selected file and perspective. To do so, if the perspective identifier indicates that the perspective is that of a user corresponding to the user system in which file opened factor identifier 722 is located, such as user system 810, file opened factor identifier 722 uses any user action indications and timestamps stored associated with the file identifier in user actions database 532, for example by office files manager 540. In one embodiment, the file opened factor is a function of the number of times the file was opened, and the age of each of those opens, with older opens having less of an influence on the file opened factor.

If the perspective identifier indicates that the perspective is that of a user corresponding to a user system other than the user system in which file opened factor identifier 722 is located, such as user system 812 or user system 814, file opened factor identifier 722 provides the file identifier to the file opened factor identifier 722 of the user system corresponding to the perspective identifier, e.g., user system 814, via peer to peer communication manager 650, along with an indication that the file opened factor should be computed for that file and returned to the originating file opened factor identifier 722 of user system 810. The receiving file opened factor identifier 722 of user system 814 computes the file opened factor as described above, using any user action indications and timestamps stored associated with the file identifier in user actions database 532 of user system 814, and returns the computed file opened factor to the originating file opened factor identifier 722 of user system 810 via peer to peer communication manager 650. Similarly, at any time, file opened factor identifier 722 of user system 810 may receive a file identifier and indication from the file opened factor identifier 722 of another user system 812, 814, and may accordingly compute and return the file opened factor for that file as described herein. When file opened factor identifier 722 has computed or obtained the file opened factor for the selected file and perspective, file opened factor identifier 722 stores the file opened factor, associated with the file identifier and the perspective identifier, in file score storage 750. File opened factor identifier 722 also provides the file identifier and the perspective identifier to file worked on factor identifier 724.

When file worked on factor identifier 724 receives the file identifier and the perspective identifier, file worked on factor identifier 724 computes or obtains a file worked on factor for the selected file and perspective. To do so, if the perspective identifier indicates that the perspective is that of a user corresponding to the user system in which file worked on factor identifier 724 is located, such as user system 810, file worked on factor identifier 724 uses any user action indications and timestamps stored associated with the file identifier in user actions database 532, for example by office files manager 540. In one embodiment, the file worked on factor is a function of the amount of time that file has recently been worked on, and the age at which the worked on times appeared in the database. File worked on factor identifier 724 may for example request and receive the current date from operating system 528, and may look for user actions of modifying the file that took place within a predetermined period of recent time, such as the past month. File worked on factor identifier 724 may determine that, when successive actions of modifying the file are recorded in user actions database 532 with no other user actions recorded as taking place between the modifications, that the file was worked on from the time of the earliest such modification to the time of the last such modification. Other techniques of determining the amount of time that files have recently been worked on may be used in other embodiments.

If the perspective identifier indicates that the perspective is that of a user corresponding to a user system other than the user system in which file worked on factor identifier 724 is located, such as user system 812 or user system 814, file worked on factor identifier 724 provides the file identifier to the file worked on factor identifier 724 of the user system corresponding to the perspective identifier, e.g., user system 814, via peer to peer communication manager 650, along with an indication that the file worked on factor should be computed for that file and returned to the originating file worked on factor identifier 724 of user system 810. The receiving file worked on factor identifier 724 of user system 814 computes the file worked on factor as described above, using any user action indications and timestamps stored associated with the file identifier in user actions database 532 of user system 814, and returns the computed file worked on factor to the originating file worked on factor identifier 724 of user system 810 via peer to peer communication manager 650. Similarly, at any time, file worked on factor identifier 724 of user system 810 may receive a file identifier and indication from the file worked on factor identifier 724 of another user system 812, 814, and may accordingly compute and return the file worked on factor for that file as described herein.

When file worked on factor identifier 724 has computed or obtained the file worked on factor for the selected file and perspective, file worked on factor identifier 724 stores the file worked on factor, associated with the file identifier and the perspective identifier, in file score storage 750. File worked on factor identifier 724 also provides the file identifier and the perspective identifier to tag factor identifier 726.

When tag factor identifier 726 receives the file identifier and the perspective identifier, tag factor identifier 726 computes or obtains a tag factor for the selected file and perspective. To do so, if the perspective identifier indicates that the perspective is that of a user corresponding to the user system in which tag factor identifier 726 is located, such as user system 810, tag factor identifier 726 finds any tags stored associated with the file identifier in user actions database 532, for example by file/subdirectory tag manager 566. Tag factor identifier 726 also uses the tag information in user actions database 532 to determine when the document was last tagged by the user; whether any of the same tags are stored associated with any other file identifiers in the database; and if so, the number of other files with which those tags are associated, and when those tags were added by the user. With reference to step 454, the tag factor may be a function of such characteristics, and may also be a function of characteristics such as the number of other users using the same tag for that document, and the number of other users using any tag corresponding to that document. To obtain this information, tag factor identifier 726 may for example provide any tags found, along with the file identifier and an indication that the corresponding tag information should be identified and returned to tag factor identifier 726 of user system 810, to the tag factor identifiers 726 of each other user system (e.g., user system 812 and user system 814) via peer to peer communication manager 650.

Similarly, tag factor identifier 726 of user system 810 may receive one or more tags along with a file identifier and indication at any time from another tag factor identifier 726 of another user system 812, 814.

When tag factor identifier 726 of any user system receives such information, the receiving tag factor identifier 726 compares uses the received tag(s) and file identifier to the tag information stored in the user actions database 532 of the user system in which that tag factor identifier 726 resides. Tag factor identifier 726 provides, via peer to peer communication manager 650 to the originating tag factor identifier 726 of the user system identified in the indication received, an indication of whether each received tag is stored associated with the identified file, and an indication of whether any tag is stored associated with the identified file.

When tag factor identifier 726 of user system 810 receives the indications from the other user systems 812, 814, tag factor identifier 726 uses the indications to determine the number of other users using the same tag for that document, and the number of other users using any tag corresponding to that document. In one embodiment, to minimize communications traffic, tag factor identifier 726 stores the indications, associated with the tag information, file identifier, and the identifier of the user system from which each indication was received, in file score storage 750. In this embodiment, before requesting tag information from other user systems, tag factor identifier 726 checks file score storage 750 to determine whether all or part of the information is already stored, and tag factor identifier 726 may request the information from only some of the user systems or may request only some of the information, as needed.

If the perspective identifier indicates that the perspective is that of a user corresponding to a user system other than the user system in which tag factor identifier 726 is located, such as user system 812 or user system 814, and if the information required to compute the tag factor is not already stored in file score storage 750, tag factor identifier 726 may additionally request and receive information from tag factor identifier 726 of the user system corresponding to the selected perspective, such as any tags associated with the selected file identifier in the user actions database 532 of that user system; when the selected file was last tagged by that user; whether any of the same tags are stored associated with any other file identifiers in the database; and if so, the number of other files with which those tags are associated, and when those tags were added by the user.

When tag factor identifier 726 has located or received all the information required to compute the tag factor, tag factor identifier 726 computes the tag factor for the selected file and the selected perspective, and stores the tag factor associated with the file identifier in file score storage 750. Tag factor identifier 726 also provides the file identifier and the perspective identifier to email factor identifier 728.

When e-mail factor identifier 728 receives the file identifier and the perspective identifier, e-mail factor identifier 728 computes or obtains an e-mail factor for the selected file and perspective. To do so, if the perspective identifier indicates that the perspective is that of a user corresponding to the user system in which email factor identifier 728 is located, e.g., user system 810, e-mail factor identifier 728 uses any e-mail information stored in user actions database 532, for example by e-mail index manager 524. In one embodiment, the e-mail factor corresponds to the number of recipients that the selected file was sent to, or received from (using the selected perspective, which corresponds to a user), weighted by the age of each e-mail, with the older e-mails having a lower weight, and the email factor may also be a function of any replies sent to such e-mails with respect to step 460.

If the perspective identifier indicates that the perspective is that of a user corresponding to a user system other than the user system in which e-mail factor identifier 728 is located, such as user system 812 or user system 814, e-mail factor identifier 728 provides the file identifier to the e-mail factor identifier 728 of the user system corresponding to the perspective identifier, e.g., user system 814, via peer to peer communication manager 650, along with an indication that the e-mail factor should be computed for that file and returned to the originating e-mail factor identifier 728 of user system 810. The receiving e-mail factor identifier 728 of user system 814 computes the e-mail factor for the selected file as described above, using any e-mail information stored in user actions database 532 of user system 814, and returns the computed e-mail factor to the originating e-mail factor identifier 728 of user system 810 via peer to peer communication manager 650. Similarly, at any time, e-mail factor identifier 728 of user system 810 may receive a file identifier and indication from the e-mail factor identifier 728 of another user system 812, 814, and may accordingly compute and return the e-mail factor for that file as described herein.

When e-mail factor identifier 728 has computed or obtained the e-mail factor for the selected file and the selected perspective, e-mail factor identifier 728 stores the e-mail factor, associated with the file identifier and the perspective identifier, in file score storage 750.

File worked on factor identifier 724 also provides the file identifier and the perspective identifier to search factor identifier 730.

When search factor identifier 730 receives the file identifier and the perspective identifier, search factor identifier 730 computes or obtains a search factor for the selected file and perspective. To do so, if the perspective identifier indicates that the perspective is that of a user corresponding to the user system in which search factor identifier 730 is located, e.g., user system 810, search factor identifier 730 compares the file identifier received to the file identifiers stored in user actions database 532 and associated with timestamps and indications that such files were found in a search or opened as a result of being found in a search, for example by search log manager 626 or search opened manager 628. In one embodiment, the search factor is a function of the number of times the file appeared at or near the top of a search performed by the user corresponding to the selected perspective, whether the user opened the file from the search results, and the age of that search, with respect to step 462. Search factor identifier 730 may weight these characteristics differently when computing the search factor.

If the perspective identifier indicates that the perspective is that of a user corresponding to a user system other than the user system in which search factor identifier 730 is located, such as user system 812 or user system 814, search factor identifier 730 provides the file identifier to the search factor identifier 730 of the user system corresponding to the perspective identifier, e.g., user system 814, via peer to peer communication manager 650, along with an indication that the search factor should be computed for that file and returned to the originating search factor identifier 730 of user system 810. The receiving search factor identifier 730 of user system 814 computes the search factor for the selected file as described above, using any search information stored in user actions database 532 of user system 814, and returns the computed search factor to the originating search factor identifier 730 of user system 810 via peer to peer communication manager 650. Similarly, at any time, search factor identifier 730 of user system 810 may receive a file identifier and indication from the search factor identifier 730 of another user system 812, 814, and may accordingly compute and return the search factor for that file as described herein.

When search factor identifier 730 has computed or obtained the search factor for the selected file and the selected perspective, search factor identifier 730 stores the search factor, associated with the file identifier and the perspective identifier, in file score storage 750. Search factor identifier 730 also provides the file identifier and the perspective identifier to sort manager 740.

When sort manager 740 receives the identifiers, sort manager 740 uses the search factor, e-mail factor, tag factor, file worked on factor, file opened factor, and completed keyword relevance factor associated with those identifiers in file score storage 750 to compute an overall probability factor for the selected file and perspective. Sort manager 740 may weight the factors differently when computing the overall probability factor. Sort manager 740 stores the overall probability factor, associated with the file identifier and perspective identifier, in file score storage 750. Sort manager 740 also signals perspective selector 714.

When signaled by sort manager 740, or by keyword relevance Factor-1 identifier 720, perspective selector 714 selects the next search perspective stored in file score storage 750, and provides that search perspective, along with the file identifier retained, to keyword relevance Factor-2 identifier 721. (In another embodiment, keyword relevance Factor-2 identifier 721 and the other factor identifiers 722-730 each retain the file identifier, and use the retained file identifier to perform the calculations and actions described herein and above, unless a new file identifier is provided.) Keyword relevance Factor-2 identifier 721 and the other factor identifiers 722-730 repeat the process described herein and above of computing and storing the search factor, e-mail factor, tag factor, file worked on factor, file opened factor, and completed keyword relevance factor for the selected file and the newly selected perspective, and sort manager 740 repeats the process of computing and storing an overall probability factor for the selected file and perspective. In one embodiment, if the completed keyword relevance factor is not greater than the threshold value for the selected file and the newly selected perspective, the other factors will not be computed. The cycle repeats for each search perspective stored in file score storage 750.

If perspective selector 714 determines that no additional search perspectives are stored in file score storage 750, perspective selector 714 signals file selector 712. When so signaled, file selector 712 selects the next file in the search space defined as part of the search parameters stored in file score storage 750, and provides an identifier of the selected file to keyword relevance Factor-1 identifier 720. Keyword relevance Factor-1 identifier 720 repeats the process described herein and above of computing or obtaining, and storing, the first part of the keyword relevance factor for the newly selected file. Keyword relevance Factor-1 identifier 720 also provides the file identifier to perspective selector 714, and perspective selector 714, the various factor identifiers 721-730, and sort manager 740 repeat the process described herein and above of computing and storing an overall probability factor for the newly selected file from each search perspective for which the completed keyword relevance factor is greater than the threshold value.

If file selector 712 determines that no additional files exist in the search space, file selector 712 signals sort manager 740. Sort manager 740 computes a combined score for each file, for example by adding the overall probability factors associated with different perspectives but the same file identifier. Sort manager 740 sorts the file identifiers in descending order of their combined scores, and the sorted list is used.

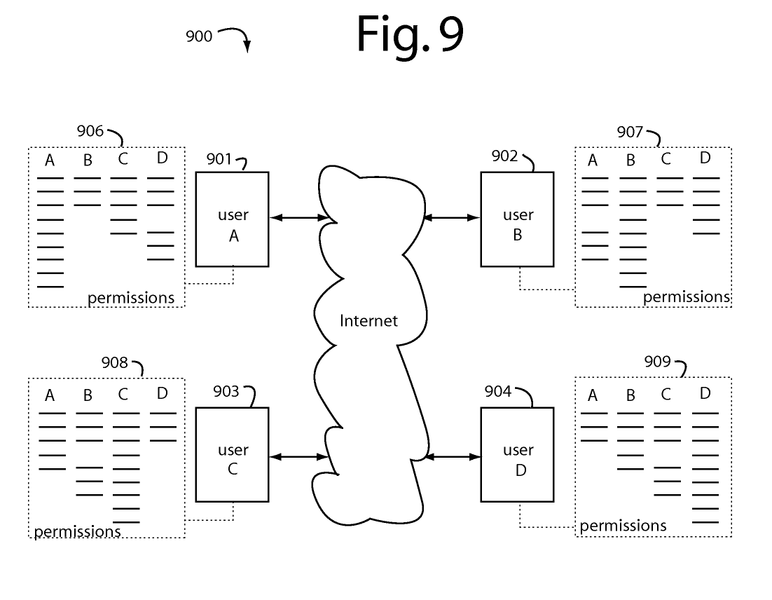

FIG. 9 represents a peer-to-peer (P2P) network embodiment of the present invention, and is referred to herein by the general reference numeral 900. P2P network 900 comprises any number of users on-line with the Internet, as represented here by users (A-D) 901-904. Each of these users has access to all of its own files, of course, and some files hosted on the other users, as represented in permission lists 906-909. Each user grants specific particular other users access to selected files owned and hosted locally. Without the appropriate permission, such files are configured to be totally invisible and completely unknown to the other users.

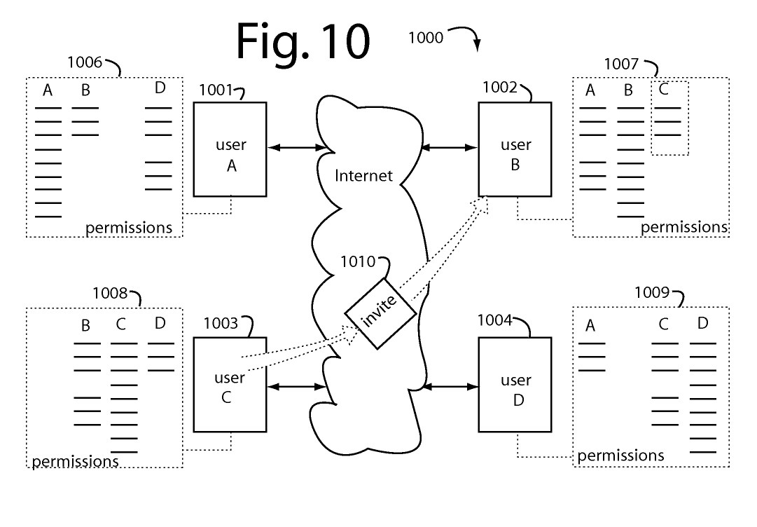

FIG. 10 represents another peer-to-peer (P2P) network embodiment of the present invention where some of the users do not have permission to access the files of some of the other users, and is referred to herein by the general reference numeral 1000. P2P network 1000 comprises many independent groups with various user memberships represented here by users 1001-1004. For example, as seen in permissions lists 1006-1009, user A 1001 has permission to access the files of itself (A), and those of users (B) 1002 and (D) 1004. It does not have access to user (C) 1003, and for all intents and purposes does not even known user (C) 1003 exists. Each user 1001-1004 can have permission to access the files of any other users, as long as those other users issue an invitation 1010 or other form of permission to share files. It is possible, therefore, to establish many different groups or subnetworks that overlap or that do not intersect at all.

Once a permission list allows it, the searches, tags, factors, usage statistics, etc., described in connection with FIGS. 1-8 can be employed in the P2P networks of FIGS. 9 and 10.

Invitation 1010 can be viral in nature. In other words, it is configured to be freely passed around and to install itself to create the entire functioning P2P networks described herein. It can be sent in an attachment to an email as an invitation to join a particular group, posted as a clickable ad on a webpage, sold on a disk, etc.

P2P networks 900 can very usefully include only those network-attached computers that belong to a single individual. For example, one's computer at work in San Francisco, the one at home in San Jose, and the one in Donetsk, Ukraine, at grandma's house that is visited for a month every summer. There is no need to email files among these computers, and no need to carry a USB drive. As long as all the computers are left powered on and connected to the Internet, they can automatically share all the files the permissions allow.

Embodiments of the present invention include peer-to-peer networks for finding and sharing document files. An enrollment mechanism includes a plurality of user computers each with their own private document files, and interconnectable over a network. A permissions list associated with each one of the plurality of user computers describes which other user computers have permission to access particular ones of the private document files. A search engine host is built on each of the plurality of user computers and provides for a document file search of each document file then included on a corresponding local permission list. A number of tags can be independently named, placed, and associated by each user computer with each of the document files then included on a corresponding local permission list. A statistic associated with the usage behavior of each document file is included on a corresponding local permission list. The search engine provides for search results that depend on a tag and a statistic.

The statistics comprise at least one of document file usage in deriving other document files, as an attachment to an email, a period of time since it was last accessed, a total number of times it has been accessed, and as a result in previous searches. No centralized index of all the private document files is used at all, unlike conventional search engines.

Instead, a mini-index of the private document files as maintained on a corresponding one of the user computers returns relevant search results for its particular collection of permitted document files. A search accumulator collects all the mini-indexes into a final search result of all user computers belonging to a particular group according to the permissions lists.

A search engine computer program for peer-to-peer networking and file sharing has an enrollment mechanism for including a plurality of user computers each with their own private document files, and interconnectable over a network. It also includes a permissions list associated with each one of the plurality of user computers that describes which other user computers have permission to access particular ones of the private document files. A mini-index of the private document files is maintained on a corresponding one of the user computers for returning relevant search results for its particular collection of permitted document files. A search accumulator combines all the mini-indexes into a final search result of all user computers belonging to a particular group.

An automatic “save . . save-as” process builds and fills a local permissions list when a user creates any document file. The declaration of who to share a document file with is intrinsic to the initial creation of such document file and not a discrete step that may or may not follow afterwards.

These programs can be implemented as self-installable application programs for emailing or downloading over the Internet that has respective sub-programs for building the enrollment mechanism, permissions list, and mini-index, as a viral payload. The payload has sub-programs for building a mini-index of the private document files as maintained on a corresponding one of the user computers for returning relevant search results for its particular collection of permitted document files. And, a search accumulator for spanning all the mini-indexes into a final search result of all user computers belonging to a particular group according to the permissions lists.

Another viral application program for peer-to-peer networking, has a self-installable application program for emailing or downloading over the Internet, and that includes processes to build an enrollment mechanism for including a plurality of user computers each with their own private document files, and interconnectable over a network; a permissions list associated with each one of the plurality of user computers that describes which other user computers have permission to access particular ones of the private document files; a mini-index of the private document files as maintained on a corresponding one of the user computers for returning relevant search results for its particular collection of permitted document files; and a search accumulator for spanning all the mini-indexes into a final search result of all user computers belonging to a particular group.

A method embodiment of the present invention for file searching includes accessing, over a network, a plurality of user computers each with their own private files. Permissions lists of document files a particular user computer is permitted to access by its local owner are obtained. Document file usage statistics are attached to each document file a particular user computer is permitted to access. And a custom tag is attached to each document file a particular user computer is permitted to access. A similarity index is computed that describes how much of one document file repeats that of another. The relevant document files are listed in an order that is dependent on the usage statistic, the custom tags, and the similarity index, and that was assembled from mini-indexes provided from user computers on the permissions lists.

A document file can be opened up locally in response to a user's clicking on a search result displayed on a local machine. Users are not required to name the document file names, nor identify which user computer it was saved.

Although particular embodiments of the present invention have been described and illustrated, such is not intended to limit the invention. Modifications and changes will no doubt become apparent to those skilled in the art, and it is intended that the invention only be limited by the scope of the appended claims.

What is claimed is:

1. A peer-to-peer network for finding and sharing document files, comprising:
an enrollment mechanism for including a plurality of user computers each with their own private document files, and interconnectable over a network;
a permissions list associated with each one of said plurality of user computers that describes which other user computers have permission to access particular ones of said private document files;
a search engine host on each of the plurality of user computers and providing for a document file search of each document file then included on a corresponding local permission list;
a number of tags that can be independently named, placed, and associated by each user computer with each of said document files then included on a corresponding local permission list; and
a statistic associated with the usage behavior of each document file then included on a corresponding local permission list;
wherein, the search engine provides for search results that depend on a tag and a statistic.

2. The peer-to-peer network of claim 1, wherein:
the statistic comprises at least one of document file usage in deriving other document files, as an attachment to an email, a period of time since it was last accessed, a total number of times it has been accessed, and as a result in previous searches.

3. The peer-to-peer network of claim 1, further comprising:
no centralized index of all said private document files.

4. The peer-to-peer network of claim 1, further comprising:
a mini-index of said private document files as maintained on a corresponding one of said user computers for returning relevant search results for its particular collection of permitted document files; and
a search accumulator for spanning all the mini-indexes into a final search result of all user computers belonging to a particular group according to the permissions lists.

5. A search engine computer program for peer-to-peer networking and file sharing, comprising:
an enrollment mechanism for including a plurality of user computers each with their own private document files, and interconnectable over a network;
a permissions list associated with each one of said plurality of user computers that describes which other user computers have permission to access particular ones of said private document files;
a mini-index of said private document files as maintained on a corresponding one of said user computers for returning relevant search results for its particular collection of permitted document files; and
a search accumulator for spanning all the mini-indexes into a final search result of all user computers belonging to a particular group.

6. The program of claim 5, further comprising:
an automatic save . . save-as process for building and filling a local permissions list when a user creates any document file;
wherein, the declaration of who to share a document file with is intrinsic to the initial creation of such document file and not a discrete step that may not follow afterwards.

7. The program of claim 5, further comprising:
a self-installable application program for emailing or downloading over the Internet that has respective sub-programs for building the enrollment mechanism, permissions list, and mini-index, as a viral payload.

8. The program of claim 7, the self-installable application program further comprising respective sub-programs for building:
a mini-index of said private document files as maintained on a corresponding one of said user computers for returning relevant search results for its particular collection of permitted document files; and
a search accumulator for spanning all the mini-indexes into a final search result of all user computers belonging to a particular group according to the permissions lists.

9. A viral application program for peer-to-peer networking, comprising:
a self-installable application program for emailing or downloading over the Internet, and that includes processes to build:
an enrollment mechanism for including a plurality of user computers each with their own private document files, and interconnectable over a network;
a permissions list associated with each one of said plurality of user computers that describes which other user computers have permission to access particular ones of said private document files;
a mini-index of said private document files as maintained on a corresponding one of said user computers for returning relevant search results for its particular collection of permitted document files; and
a search accumulator for spanning all the mini-indexes into a final search result of all user computers belonging to a particular group.

10. A method for file searching, comprising:
accessing over a network a plurality of user computers each with their own private files;
obtaining permissions lists of document files a particular user computer is permitted to access by its local owner;
attaching a document file usage statistic to each document file a particular user computer is permitted to access;
attaching a custom tag to each document file a particular user computer is permitted to access;
computing a similarity index that describes how much of one document file repeats that of another; and
listing relevant document files an order that is dependent on said usage statistic, said custom tags, and said similarity index, and that was assembled from mini-indexes provided from user computers on said permissions lists.

11. The method of claim 10, further comprising:
opening up a document file locally in response to a user's clicking on a search result displayed on a local machine.

12. The method of claim 10, wherein, users are not required to name the document file names, nor identify which user computer it was saved.
